(19) United States
(12) Patent Application Publication
(10) Pub. No.: US 2007/0248120 A1
(43) Pub. Date: Oct. 25, 2007

(54) Device for increasing bandwidth in a cable network

(75) Inventors: Schah Walli Ali, Boca Raton, FL (US); Thomas Nagel, Boca Raton, FL (US)

Correspondence Address: Siemens Corporation;Intellectual Property Department, 170 Wood Avenue South, Iselin, NJ, 08830, US

(73) Assignee: Siemens Aktiengesellschaft

(21) Appl. No.: 11/715,532

(22) Filed: Mar. 8, 2007

Related U.S. Application Data
(60) Provisional application No. 60/794,722, filed on Apr. 25, 2006.

(51) Int. Cl. H04H 1/00

(52) U.S. Cl. 370/486

(57) ABSTRACT

In one aspect, a device that communicates with a customer premises equipment of a subscriber via a coaxial cable is provided. The device increases the upstream traffic for the subscriber. Furthermore, the device is migrated into a network such that the subscriber does not have to change their customer premises equipment.

### CROSS-REFERENCE To RELATED APPLICATIONS

The present application claims the benefit of the provisional patent application filed on Apr. 25, 2006, and assigned application No. 60/794,722.

### FIELD OF THE INVENTION

The present invention relates to increasing bandwidth in a network, and more particularly, to increasing the bandwidth in a cable network by migrating an optical component that communicates with a customer premises equipment (CPE) via a coaxial cable.

### BACKGROUND

Network providers are often faced with the desire to increase the bandwidth in their network. The term “bandwidth” is used to describe the width of the range of frequencies that a signal uses on a transmission medium as well as to describe a transfer rate of data on the transmission medium. In the use of bandwidth to describe the range width of a signal, the bandwidth is expressed in hertz (the number of cycles of change per second) and calculated as the difference in hertz between the highest frequency for the signal and the lowest signal for the signal. In the use of bandwidth to describe a transfer rate, the bandwidth is expressed in bits per second (bps). An increase in the width of the range of frequencies increases the transfer rate. Likewise, a decrease in the width of the range of frequencies decreases the transfer rate.

### SUMMARY OF THE INVENTION

An aspect of the present invention involves a device that communicates with a customer premises equipment of a subscriber via a coaxial cable. The device comprises a coaxial interface, a receiver and a burst demodulator. The coaxial interface connects the optical device to a plurality of customer premises equipment via a coaxial cable having a length of one mile or less. The receiver converts a first optical downstream traffic from a network to a first downstream traffic with an electrical signal, wherein the first electrical downstream traffic is sent to the customer premises equipment via the coaxial cable. A burst demodulator converts an electrical upstream traffic received from the customer premises equipment via the coaxial cable to an upstream traffic with an optical signal with a second wavelength, wherein the optical upstream traffic is sent to the network.

Another aspect of the present invention involves a device that communicates with a subscriber via a coaxial cable. The device comprises a receiver, a burst demodulator, and an out-of-band modulator. The receiver converts a first optical downstream traffic from a network to a first downstream traffic with an electrical signal, wherein the first electrical downstream traffic is sent to the customer premises equipment via the coaxial cable. The burst demodulator converts an electrical upstream traffic received from the customer premises equipment via the coaxial cable to an upstream traffic with an optical signal with a second wavelength, wherein the optical upstream traffic is sent to the network. The out-of-band modulator converts a second optical downstream traffic from the network with a third wavelength to a second downstream traffic with an electrical signal, wherein the second electrical downstream traffic is added to the first electrical downstream traffic to form a third electrical downstream traffic, wherein the third electrical down stream traffic is sent to the customer premises equipment via the coaxial cable.

Yet another aspect of the present invention involves a device that communicates with a subscriber via a coaxial cable. The device comprises an electrical upstream traffic, and a burst demodulator. The electrical upstream traffic is received from the subscriber via the coaxial cable. The burst demodulator converts the electrical upstream traffic to an upstream traffic with an optical signal with a second wavelength, wherein the optical upstream traffic is sent to the network, wherein the electrical upstream traffic received by the burst demodulator is in a format related to a cable protocol, which is converted to an format related to an optical protocol via the burst demodulator.

### BRIEF DESCRIPTION OF THE DRAWINGS

The above mentioned and other concepts of the present invention will now be described with reference to the drawings of the exemplary and preferred embodiments of the present invention. The illustrated embodiments are intended to illustrate, but not to limit the invention. The drawings contain the following figures, in which like numbers refer to like parts throughout the description and drawings wherein:

FIG. 1a illustrates a prior art schematic diagram of an exemplary hybrid fiber coax (HFC) network;

FIG. 1a illustrates a prior art schematic diagram of an exemplary optical network terminal (ONT);

FIG. 2 illustrates a schematic diagram of an exemplary embodiment of a HFC network with a migrated optical component;

FIG. 3 illustrates a schematic diagram of another exemplary embodiment of a HFC network with a migrated optical component;

FIG. 4 illustrates an exemplary embodiment of an ONT; and

FIG. 5 illustrates an exemplary embodiment of an ONT that communicates bi-directionally to the subscriber via a coaxial cable.

### DETAILED DESCRIPTION OF THE INVENTION

The invention described herein may employ one or more of the following concepts. For example, one concept relates an optical component that is migrated into a cable network. Another concept relates to providing a higher quality of service in the network via the optical component. Another concept relates to allowing a subscriber to keep their current customer premises equipment without modification. Another concept relates to the optical component providing only an upstream path from the subscriber to the network. Yet another concept relates to the optical component providing only a downstream path from the network to the subscriber. Still another concept relates to the optical component providing an upstream and downstream path between the subscriber and the network.

The exemplary embodiments of the invention are disclosed in context of use of a HFC network. The principles of the present invention, however, are not limited to use within an HFC network but may be applied to other cable networks wherein coaxial cable is used to connect a subscriber to the network. Also, while the exemplary embodiments is an Optical Network Terminal (ONT) for migrating into an HFC network, other optical network devices that terminate to a subscriber may be used, such as an Optical Network Unit (ONU). Additionally, while the exemplary embodiments are disclosed in context of use with wavelengths of 1310 nm, 1490 nm, and 1550 nm, the principles of the invention are not limited to use of wavelengths 1310 nm, 1490 nm and 1550 nm. Thus, the illustration and description of the present invention in context of an ONT for migrating into the HFC network is merely one possible application of the present invention.

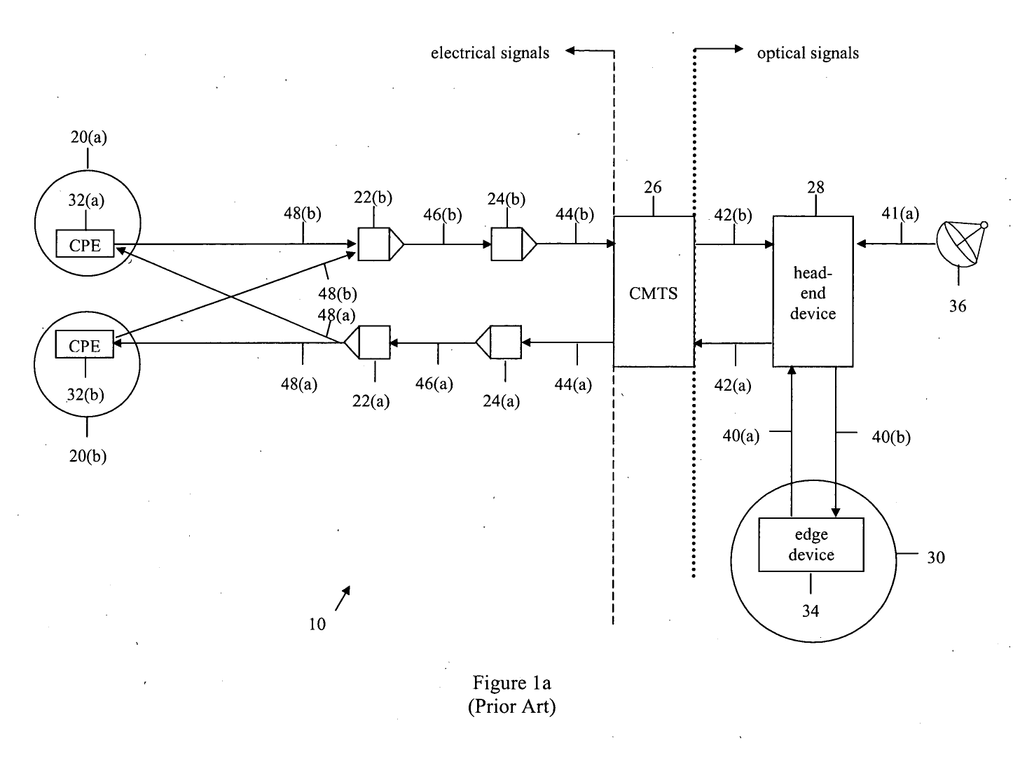

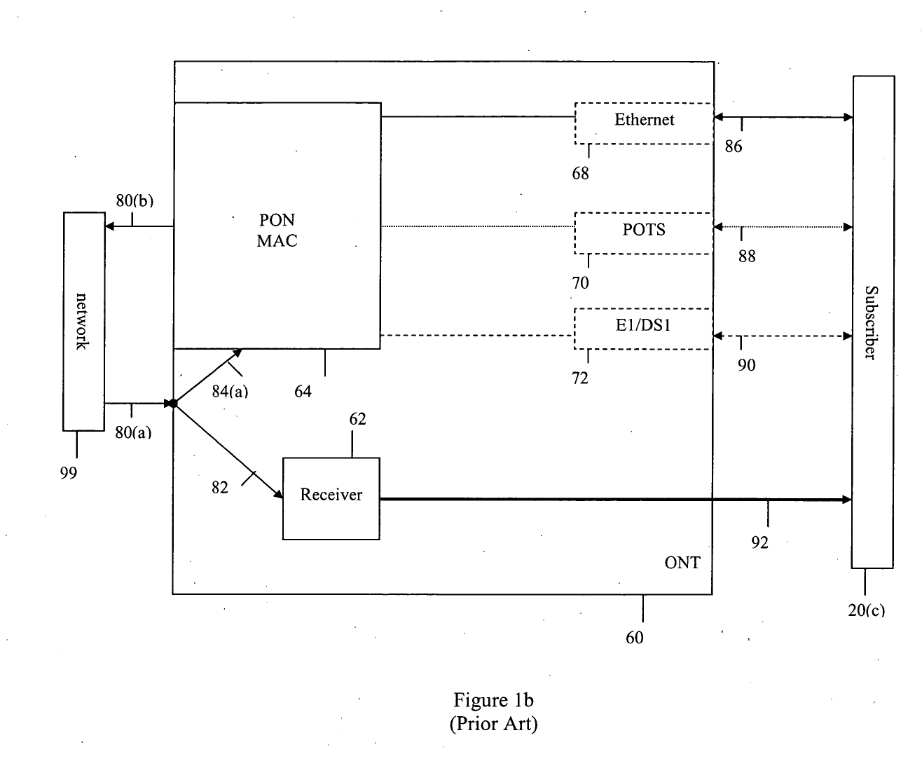

Referring to FIG. 1a, a prior art schematic diagram of an exemplary HFC network 10 is illustrated. The HFC network 10 is a cable network that includes a combination of optical components and coaxial cable. The optical components provides the high-speed backbone and coaxial cable is used to connect the subscribers 20 to the backbone. The exemplary HFC network 10 includes a plurality of subscribers 20, a plurality of amplifiers 22, a plurality of filters 24(b) a Cable Modem Termination System (CMTS) 26, a head-end device 28, a satellite receiver 36, and an Internet Service Provider (ISP) 30.

The subscriber 20 includes a CPE 32, such as a cable modem, which is coupled to the network via a coaxial cable. Throughout this document, the term “coupled” refers to any direct or indirect communication between two or more elements in the network 10, whether or not those elements are in physical contact with one another.

The coaxial cable is coupled to amplifiers 22 and filters 24 to amplify and filter the traffic on the coaxial cable. The term “traffic” refers to a packet, a message, streams, or other suitable form(s) of data, voice or combinations thereof. The coaxial cable is further coupled to the CMTS 26, which is coupled to the head-end device 28. The head-end device 28 is further coupled to the ISP 30 via an edge device 34 and may be coupled to other devices such as a satellite receiver 36.

Traffic in the direction toward the subscriber is considered downstream traffic 40(a), 41(a), 42(a), 44(a), 46(a), 48(a). Traffic in the direction toward the ISP 30 is considered upstream traffic 40(b), 42(b), 44(b), 46(b), 48(b). The head-end device 28 may receive traffic 40(a) from the ISP 30 or other devices such as the satellite receiver 36. Additionally, the head-end device 28 may send traffic 40(b) to the ISP 30. Traffic 40 between the head-end device 28 and the ISP 30 is handled via optical components, thus the traffic is based on optical signals.

Additionally, traffic 42 between the head-end device 28 and the CMTS 26 is handled via optical components. The head-end device 28 multiplexes the received traffic 41(a), 40(a) using frequency-division multiplexing (FDM) into an aggregated traffic 42(a), which is sent downstream to the CMTS 34.

The CMTS 34 converts the incoming traffic 42(a) from optical signals to an outgoing traffic 44(a) with electrical signals. The converted traffic 44(a) is fed into the hi-pass filter 24(a) to reduce low frequency noise and thereby producing traffic 46(a) having an electric signal with a frequency range of approximately 54-860 MHz.

The traffic 46(a) is fed into an amplifier 22(a). The amplified traffic 48(a) is sent to the subscribers 20 via the respective CPE 32.

In the upstream path, the subscriber 20 sends traffic 48(b) to the network 10 via the respective CPE 32. The traffic 48(b), which has an electric signal with a frequency range of approximately 5-42 MHz is amplified via an amplifier 22(b). The amplified traffic 46(b) is fed into the low-pass filter 24(b) to reduce high frequency noise and thereby producing traffic 44(b). The traffic 44(b) is sent to the CMTS 34 where the signal is converted from electrical signals to a traffic 42(b) having optical signals. Then the traffic 42(b) is sent to the head-end device 28 and traffic 40(b) is sent to the edge device 34.

Both the downstream bandwidth and the upstream bandwidth are shared between up to approximately 2000 subscribers. Consequently, the usable bandwidth per subscriber is limited if all the subscribers are active at the same time. Furthermore, the upstream frequency range may experience noise interference due to signals within or approximately within the upstream frequency range, such as ham radio citizen band (CB).

Network providers face many demands for bandwidth. For example, subscribers may request higher speed access. Also, new services may be added to the network, which will need to share the bandwidth. Moreover, some services require relatively large amounts of bandwidth, e.g. video services, in both the upstream and the downstream directions. Consequently, network providers are challenged in providing sufficient bandwidth in order to fulfill the requirements of the services and the demands of subscribers. In particular, cable networks such as the HFC network 10 are challenged due to the relative low bandwidth of approximately 30 Mbps in the upstream direction.

In order to provide the sufficient bandwidth, in order to fulfill the service requirements and subscriber demands, changes to the HFC network 10 are needed to increase the bandwidth. This may be achieved by converting the HFC network 10 a Passive Optical Network (PON) network. The PON would include optical components such as an exemplary ONT 60 as illustrated in FIG. 1b.

Referring now to FIG. 1b, a schematic diagram of an exemplary prior art ONT 60 is shown. The ONT 60 includes a Receiver 62, a PON MAC 64, an Ethernet connector 68, a Plain Old Telephone Service (POTS) connector 70, and an E1/DS1 connector 72. The ONT 60 communicates bi-directionally with a network 99 via a traffic 80 having optical signals.

The downstream traffic 80(a) from the network 99 to the ONT 60 includes a signal having a 1550 nm wavelength and a signal having a 1490 nm wavelength. The downstream traffic 80(a) is split by the ONT 60 so that the Receiver 62 receives the traffic 82 with the 1550 nm wavelength and the PON MAC receives the traffic 84 with the 1490 nm wavelength. The receiver converts the traffic 82, which is used for cable television from an optical signal to traffic 92 with an electrical signal. The downstream traffic 92 to the subscriber 20(c) is unidirectional. The traffic 84 received by the PON MAC 64 is sent to the subscriber via the Ethernet connector 68, the POTS connector 70, or the Electrical Interface Level 1 (E1)/Digital Signal Level 1 (DS1) connector 72. The Ethernet connector 68 allows a bidirectional traffic 86 for voice, audio, and data between the ONT 60 and the subscriber 20(c). The POTS connector 70 and the E1/DS1 connector 72 provide telephone service to the subscriber 20(c) via the bidirectional traffic 88, 90. Upstream traffic 86, 88, 90 from the subscriber 20(c) is processed via the PON MAC. The PON MAC 64 sends an upstream traffic with signal having a 1310 nm wavelength.

A complete changeover to a PON would not leverage the current cable network 26 infrastructure and would be costly to implement. Furthermore, in a complete changeover a subscriber 20 would not be able to keep their CPE 32. Additionally, it may be desirable to migrate only a part of the network to have certain features of the PON.

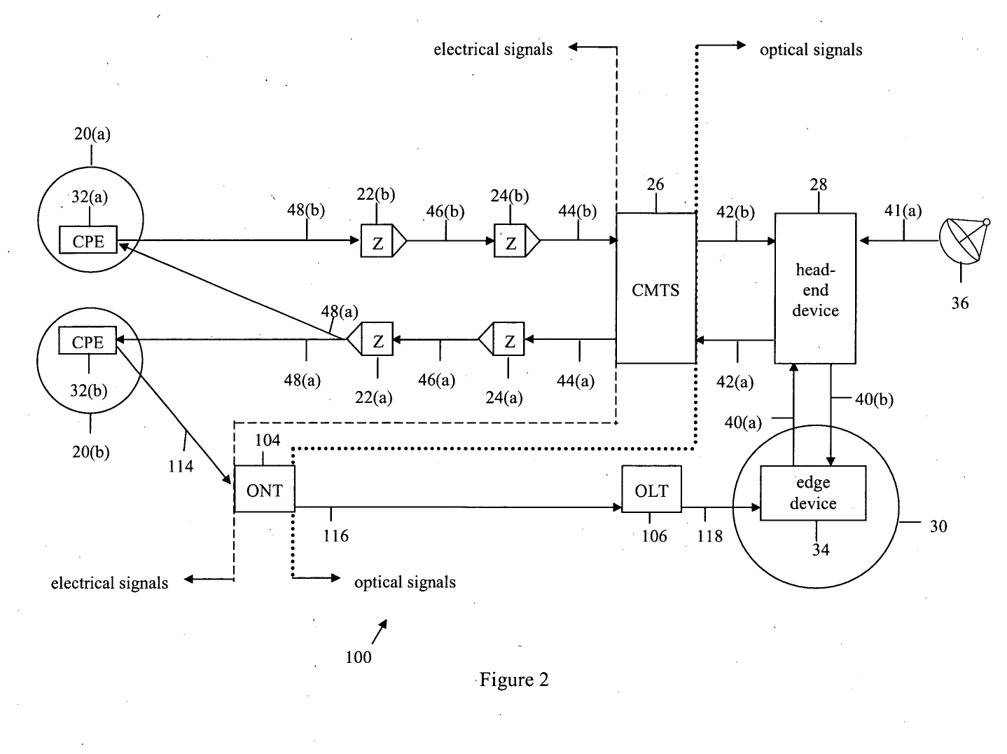

Referring now to FIG. 2, a schematic diagram of an exemplary embodiment of a HFC network 100 is illustrated. The exemplary HFC network 100 includes a plurality of subscribers 20, a head-end device 28, a satellite receiver 18, an Internet Service Provider (ISP) 30, an Optical Network Terminal (ONT), 104 and Optical Line Terminal (OLT) 106. The ONT 104 is coupled to the subscriber via a coaxial cable and optically to the OLT 106. The OLT 106 is further coupled to the edge device 34. The ONT 104 and OLT 106 have been migrated into the HFC network 100 to provide an upstream traffic for at least a portion of the subscribers 20(b) in the network 100 as described below. In the exemplary embodiment, the ONT 104 is physically closer to the subscriber 20(b) than the filter 22.

For subscriber 20(a), the downstream traffic 40(a), 41(a), 42(a), 44(a), 46(a), 48(a) and the upstream traffic 48(b), 46(b), 44(b), 42(b), 40(b) is as described for FIG. 1a. For subscriber 20(b), the downstream traffic 40(a), 41(a), 42(a), 44(a), 46(a), 48(a) is also as described for FIG. 1a; however, the upstream traffic 114, 116, 118 utilizes the migrated ONT 104 and OLT 106. Each ONT 104 would a serve a relatively small subset of subscribers 20(b) in comparison to the number of subscribers 20 served by the network 10 in FIG. 1a. For example the ONT 104 may serve 100 or less subscribers 20(b). By serving fewer subscribers 20(b), the number of subscribers 20(b) having to share the upstream bandwidth is decreased. Thus, each subscriber 20(b) may use more upstream bandwidth. The upstream bandwidth is increased above 30 Mbps.

Additionally, by migrating the ONT 104 relatively close to the subscriber 20(b), e.g. approximately within 1 mile, the potential for noise interference in the upstream traffic 114, 116, 118 is reduced. Therefore, a desired increase in the signal to noise ratio is achieved. This reduction is due to a smaller distance in which the upstream traffic 114 travels in the coax cable. Also, if the ONT 104 is migrated to replace the last amplifier 22 prior to the subscriber 20(b), the signal to noise ration may be increased since the upstream traffic does not have to be amplified by the amplifiers 22(b) in the cable network 26.

Also, the migration allows the subscriber 20(b) to use their existing CPE 32(b). Thus the subscriber 20(b) would not need to make any changes to the hardware, software, or connections of the CPE 32. Therefore, the subscriber 20(b) may not be aware of changes to the HFC network 100 except for maybe positive aspects, such as an increased performance or a service enhancement. In contrast, if the subscriber 20(b) has to change the CPE 32 the subscriber may choose instead to use a competitor's network.

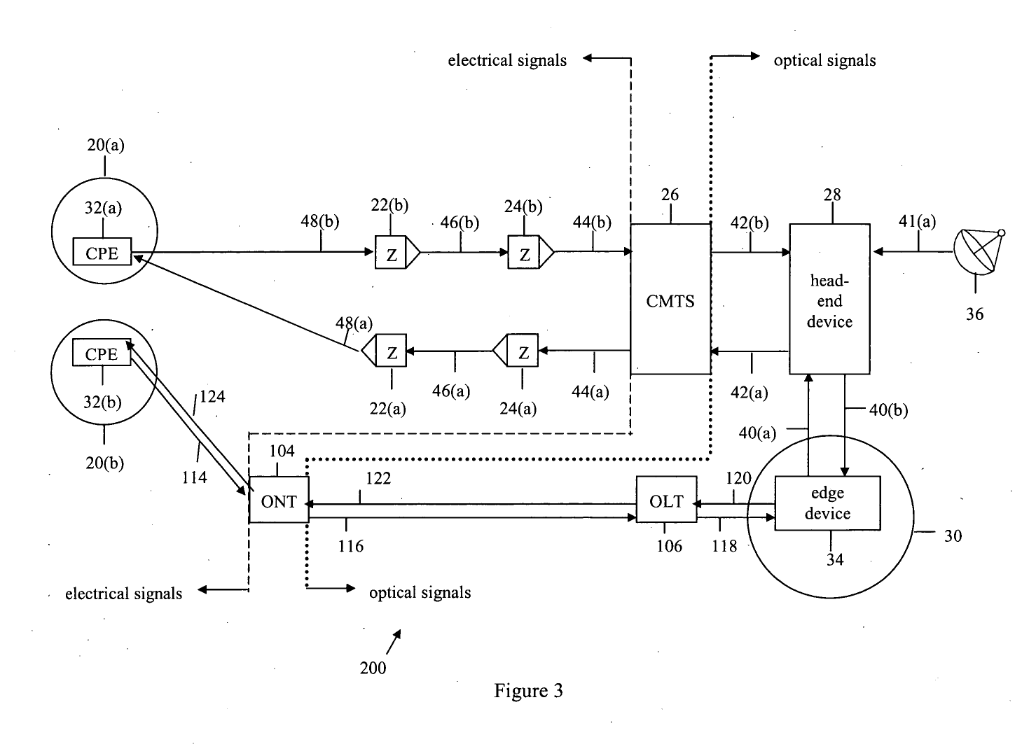

Referring now to FIGS. 2 and 3, a schematic diagram of another exemplary embodiment of a HFC network 200 is illustrated. In the exemplary embodiment illustrated by FIG. 3, the HFC network 100 has been further migrated use the ONT 104 and OLT 106 to provide a downstream traffic 120, 122, 124 for the subscribers 20(b). Since the number of subscribers 20(b) coupled to the ONT 104 is less than the number of subscriber 20, the number of subscribers 20(b) having to share the downstream bandwidth from the ONT 104 is decreased. Thus, each subscriber 20(b) may use more downstream bandwidth.

Since the ONT 104 is relatively close to the subscriber 20(b), the potential for noise interference is for the downstream traffic is reduced.

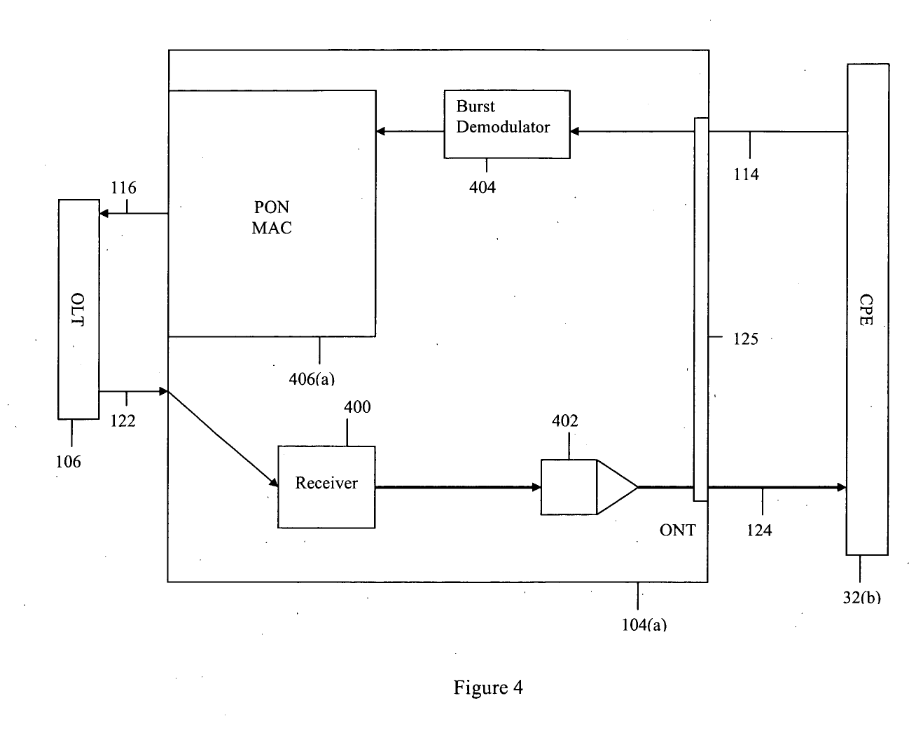

Referring now to FIGS. 3 and 4, an exemplary embodiment of an ONT 104 is illustrated. The exemplary ONT 104(a) includes a receiver 400, an amplifier 402, a burst demodulator 404, a coaxial connector 125, and a PON MAC 406(a). A bidirectional communication is provided between the ONT 104(a) and the CPE 32(b) via a coaxial cable allowing the downstream traffic 124 and the upstream traffic 122. The coaxial cable is coupled to the ONT 104 via the coaxial connector 125. A bidirectional communication is also provided between the OLT 106 and the ONT 104(a) allowing the downstream traffic 122 and the upstream traffic 116.

The ONT 104(a) receives the optical downstream traffic 122 from the OLT 106 with an optical signal having a 1550 nm wavelength. The receiver 400 converts the received optical traffic 122 to a traffic with an electrical signal, which is amplified by the amplifier 402. The amplified traffic 122 is sent to the CPE 32(b) via the coaxial cable. The downstream traffic 122, 124 is for a television service.

Upstream electrical traffic 114 received by the ONT 104(a) from the CPE 23(b) via the coaxial cable is sent to the burst demodulator 404. The burst demodulator 104(a) converts the upstream traffic 114 from an electrical signal having a cable protocol, such as DOCSIS or DAVIC, to an optical signal that is sent to the PON MAC 406. The burst demodulator 104(a) may be configured to handle a single cable protocol or a plurality of protocols. The electrical signal is converted to an optical signal with a 1490 nm wavelength. The optical upstream traffic 116 is sent to the OLT 106. The upstream traffic 114, 116 is for a data, voice and/or television service.

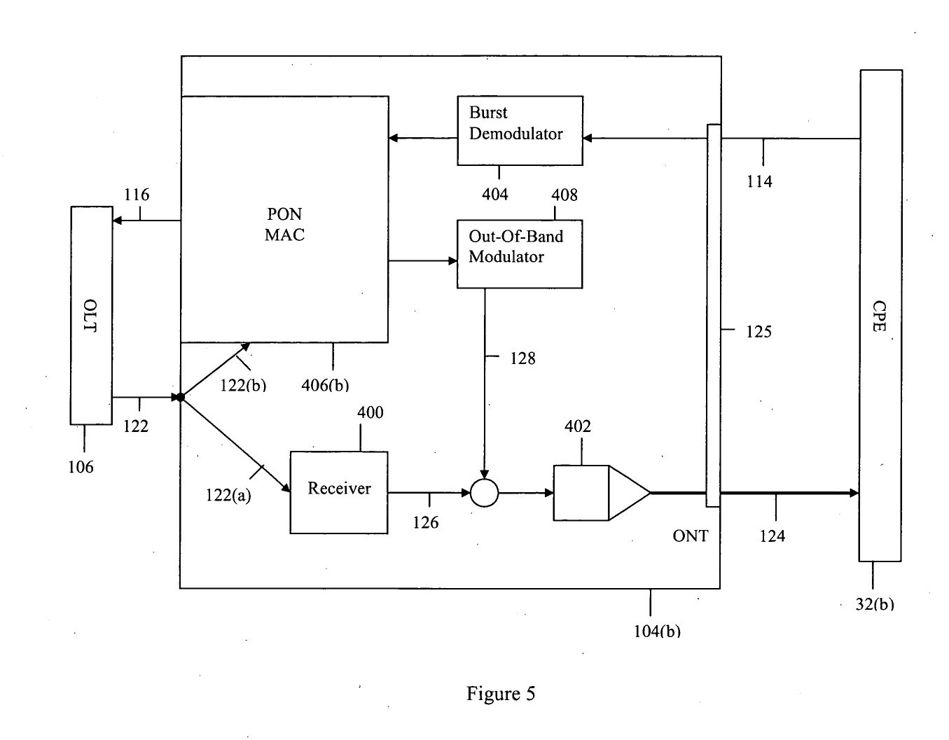

Referring now to FIGS. 3 and 5, another exemplary embodiment of an ONT 104 is illustrated. The exemplary ONT 104(b) includes a receiver 400, an amplifier 402, a burst demodulator 404, a PON MAC 406(b), a coaxial connector 125, and an out-of-band (OOB) modulator 408. A bidirectional communication is provided between the ONT 104(b) and the CPE 32(b) via a coaxial cable allowing the downstream traffic 124 and the upstream traffic 122. The coaxial cable is coupled to the ONT 104 via the coaxial connector 125. A bidirectional communication is also provided between the OLT 106 and the ONT 104(b) allowing the downstream traffic 122 and the upstream traffic 116.

The ONT 104(b) receives the optical downstream traffic 122 from the OLT 106 with an optical signal having a 1550 nm wavelength and an optical signal having a 1490 nm wavelength. The OLT splits the received traffic 122 such that the receiver 400 receives traffic 122(a) with the 1550 nm wavelength and the PON MAC 406(b) receives the traffic 122(b) with the 1490 nm wavelength.

The receiver converts the received optical traffic 122(a) to a traffic 126 with an electrical signal. The OOB demodulator 408 converts the received optical traffic 122(b) to a traffic 128 with an electrical signal in accordance with a cable protocol, such as DOCSIS or DAVIC. The OOB demodulator 408 may be configured to handle a single cable protocol or a plurality of protocols. The traffic 126 and the traffic 128 are added together and amplified by the amplifier 402 to form the traffic 122 that is sent to the CPE 32(b) via the coaxial cable. The downstream traffic 122(a) is for a television service and the downstream traffic 122(b) is for a voice or data service. The amplified traffic 124 is may include signals for data, voice and/or television service

The ONT 104(b) receives upstream electrical traffic 114 from the subscriber via the coaxial cable. The upstream traffic 114 is sent to the burst demodulator 404. The burst demodulator 104(b) converts the upstream traffic 114 from an electrical signal having a cable protocol, such as DOCSIS or DAVIC, to an optical signal that is sent to the PON MAC 406. The burst demodulator 104(b) may be configured to handle a single cable protocol or a plurality of protocols. The optical upstream traffic 116 is sent to the OLT 106 via the PON MAC 406.

Having the ONT 104 communicate bi-directionally to the CPE 32(b) via the coaxial cable facilitates allowing the subscriber to keep their CPE. Moreover, as previously described, by migrating the ONT 104 to a relatively small subset of subscribers, the bandwidth is increased between the subscribers 20(b) which share to coaxial cable.

Also, having the ONT 104 convert via Burst Demodulator 404 and/or the OOB Modulator 408 between the cable protocol and the optical signal further facilitates allowing the subscriber to keep their CPE. Furthermore, other connections do not need to be added to the subscriber to allow traffic between the CPE 32(b) and the ONT 104, thereby reducing installation time and overhead.

While the invention has been described in terms of a certain preferred embodiment and suggested possible modifications thereto, other embodiments and modifications apparent to those of ordinary skill in the art are also within the scope of this invention without departure from the spirit and scope of this invention. For example, a HFC 100, 200, 300 is not limited to a single ISP 30 and may have more filters 24 and amplifiers 22. Furthermore, it would be understood by those of ordinary skill in the art that a plurality of ONT 104 and/or OLT 106 may be migrated into the network. Thus, the scope of the invention should be determined based upon the appended claims and their legal equivalents, rather than the specific embodiments described above.

1. A device that communicates with a customer premises equipment of a subscriber via a coaxial cable, comprising:
a coaxial interface that connects the optical device to a plurality of customer premises equipment via a coaxial cable having a length of one mile or less;
a receiver that converts a first optical downstream traffic from a network to a first downstream traffic with an electrical signal, wherein the first electrical downstream traffic is sent to the customer premises equipment via the coaxial cable; and
a burst demodulator that converts an electrical upstream traffic received from the customer premises equipment via the coaxial cable to an upstream traffic with an optical signal with a second wavelength, wherein the optical upstream traffic is sent to the network.

2. The device as claimed in claim 1, wherein the electrical upstream traffic received by the burst demodulator is in a format related to a cable protocol, which is converted to a format related to an optical protocol via the burst demodulator.

3. The device as claimed in claim 2, wherein the cable protocol is based on a DOCSIS or DAVIC protocol.

4. The device as claimed in claim 1,
wherein the first wavelength comprises a television service of the subscriber,
wherein the electrical upstream signal comprises a service selected from the group consisting of voice service, data service, television service, and combinations thereof, and
wherein the third wavelength comprises a service selected from the group consisting of voice service, data service, television service, and combinations thereof.

5. The device as claimed in claim 1, wherein the first electrical wavelength is amplified prior to sending to the customer premises equipment.

6. The device as claimed in claim 1, further comprising:
an out-of-band modulator that converts a second optical downstream traffic from the network with a third wavelength to a second downstream traffic with an electrical signal,
wherein the second electrical downstream traffic is added to the first electrical downstream traffic to form a third electrical downstream traffic, and
wherein the third electrical down stream traffic is sent to the customer premises equipment via the coaxial cable.

7. The device as claimed in claim 6,
wherein the first wavelength comprises a television service of the subscriber,
wherein the second wavelength comprises a service selected from the group consisting of voice service, data service, and combinations thereof,
wherein the electrical upstream signal comprises a service selected from the group consisting of voice service, data service, television service, and combinations thereof,
wherein the third wavelength comprises a service selected from the group consisting of voice service, data service and combinations thereof, and
wherein the third electrical downstream traffic comprises a service selected from the group consisting of voice service, data service, television service and combinations thereof.

8. The device as claimed in claim 6, wherein the third electrical wavelength is amplified prior to sending to the subscriber.

9. A device that communicates with a subscriber via a coaxial cable, comprising:
a receiver that converts a first optical downstream traffic from a network to a first downstream traffic with an electrical signal, wherein the first electrical downstream traffic is sent to the customer premises equipment via the coaxial cable;
a burst demodulator that converts an electrical upstream traffic received from the customer premises equipment via the coaxial cable to an upstream traffic with an optical signal with a second wavelength, wherein the optical upstream traffic is sent to the network; and
an out-of-band modulator that converts a second optical downstream traffic from the network with a third wavelength to a second downstream traffic with an electrical signal, wherein the second electrical downstream traffic is added to the first electrical downstream traffic to form a third electrical downstream traffic,
wherein the third electrical down stream traffic is sent to the customer premises equipment via the coaxial cable.

10. The device as claimed in claim 9,
wherein the first wavelength comprises a television service of the subscriber,
wherein the second wavelength comprises a service selected from the group consisting of voice service, data service, and combinations thereof,
wherein the electrical upstream signal comprises a service selected from the group consisting of voice service, data service, television service, and combinations thereof,
wherein the third wavelength comprises a service selected from the group consisting of voice service, data service and combinations thereof, and
wherein the third electrical downstream traffic comprises a service selected from the group consisting of voice service, data service, television service and combinations thereof.

11. The device as claimed in claim 9, wherein the third electrical wavelength is amplified prior to sending to the subscriber.

12. The device as claimed in claim 9, wherein the device is located within the last mile of coax cable toward the subscriber.

13. The device as claimed in claim 9, wherein the optical upstream traffic is greater than 50 Mbps.

14. A device that communicates with a subscriber via a coaxial cable, comprising:
an electrical upstream traffic received from the subscriber via the coaxial cable;
a burst demodulator converts the electrical upstream traffic to an upstream traffic with an optical signal with a second wavelength,
wherein the optical upstream traffic is sent to the network,
wherein the electrical upstream traffic received by the burst demodulator is in a format related to a cable protocol, which is converted to an format related to an optical protocol via the burst demodulator.

15. The device as claimed in claim 14, wherein the device does not receive a downstream traffic for the customer premises equipment.

16. The device as claimed in claim 14, further comprising a receiver for a future migration of receiving a first downstream traffic with a first wavelength, wherein the receiver is configured to convert the first downstream traffic to a first traffic with an electrical signal to be sent to the subscriber via the coaxial cable;

17. The device as claimed in claim 14, wherein device is located within the last mile of coax cable toward the subscriber.

18. The device as claimed in claim 16, wherein the optical upstream traffic is greater than 50 Mbps.

19. The device as claimed in claim 16, wherein the device is located within the last mile of coax cable toward the subscriber.

20. The device as claimed in claim 16, wherein the cable protocol is based on a DOCSIS or DAVIC protocol.
